(19) United States
(12) Patent Application Publication
(10) Pub. No.: US 2011/0072361 A1
(43) Pub. Date: Mar. 24, 2011

(54) COMMUNICATION APPARATUS

(75) Inventors: Masaki SAKAI, Tokyo (JP); Natsuko Ouchi, Tokyo (JP)

(73) Assignee: KABUSHIKI KAISHA TOSHIBA, Tokyo (JP)

(21) Appl. No.: 12/876,322

(22) Filed: Sep. 7, 2010

(30) Foreign Application Priority Data
Sep. 18, 2009 (JP) P2009-217918

(51) Int. Cl. G06F 3/01

(52) U.S. Cl. 715/745

(57) ABSTRACT

According to one embodiment, a communication apparatus includes a storage unit, a generating unit, and a display unit. The storage unit is configured to store operation history each time an operation is performed. The generating unit is configured to retrieve operation history information from the storage unit. And the generating unit is also configured to generate recommended information based on the operation history information. The display unit displays a home screen as a starting point of operation so that the home screen contains the recommended information generated by the generating unit.

### CROSS-REFERENCE TO RELATED APPLICATIONS

This application is based upon and claims the benefit of priority of Japanese Patent Application No. 2009-217918, filed Sep. 18, 2009, the entire contents of which are incorporated herein by reference.

### FIELD

Embodiments described herein relate generally to a communication apparatus that displays a screen functioning as a starting point of the user's operation (“home screen”).

### BACKGROUND

Communication apparatuses such as Personal Digital Assistants (PDA) and Personal Computers (PC) typically have a function of displaying a screen from which the user can start operation (a home screen) on a display. Today, more and more of these communication apparatuses are equipped with a touch panel, and design of a UI utilizing a touch panel and having excellent user operability is an issue in developing apparatuses by manufacturers. Particularly in the design of a UI of the home screen, how easily users can call a desired function is one of primary design goals.

Meanwhile, in development of element technology for application to communication apparatuses, active research and development have been conducted on algorithms for recommending certain functions to users based on terminal position information, user's operation history, time, information obtained from networks, and the like. For example, a “recommendation engine,” which is a process implementing an algorithm for recommending certain features to a user, is capable of outputting applications stored within the communication apparatus, a telephone call accompanied by registered contact information (e.g., personal data of a peer such as a telephone number, mail address saved in an address book, or a URL of a blog site), composition of an e-mail message, web browsing on a browser, and web access information (e.g., a URL and a title of a website).

As a device to recommend functions to a user, an electric appliance controller is proposed that can autonomously and automatically control the operation of an appliance or the like ahead of the user's action without requiring setting or operation by the user, for example (see Patent Document 1 (Japanese Patent Laid-Open No. 2001-273395)). This electric appliance controller comprises: an input/output terminal for outputting an instruction from the user and displaying the result of executing the instruction; an input/output unit for giving an instruction to the input/output terminal and inputting the result of execution; a communication control unit for communicating with electric appliances; an operation control unit for controlling operation of each of the electric appliances; a date/time managing unit for managing time information; an electric-appliance information managing unit for managing electric appliance information; an operation-history information managing unit for managing operation history information for each of the electric appliances; and a database managing unit for centrally managing a database in which electric appliance information and operation history information are stored.

It is preferred to reduce a number of operation steps required for calling functions on a home screen of a communication apparatus. Such function is, for example, to open an application or a file frequently used by the user, to make a telephone call based on contact information (e.g., personal data of a peer such as a telephone number or a mail address saved in an address book), to compose a mail message, or to connect to and browse the website of web access information (e.g., a URL and a title of the website). To reduce the steps, such a scheme has been adopted that provides shortcuts for such applications/files, contact information, and access information in the form of icons or widgets (accessory software operating on a desktop) on the home screen. And shortcut icons and widgets can be laid out on the home screen by the user as convenient for him/her based on a premise that the user performs setting operations. However, these schemes have a problem of taking time and trouble for the user to configure icons and widgets on the home screen.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic external perspective view showing an example of a communication apparatus according to an embodiment of the present invention;

FIG. 2 is a schematic block diagram showing an example of the features of the communication apparatus;

FIG. 3 is a schematic block diagram showing an example of a software configuration of the communication apparatus for displaying a home screen;

FIG. 4 is a flowchart showing an example of a procedure of a recommendation list generating process of the communication apparatus;

FIG. 5 is a subroutine flowchart showing a procedure of an application/file list generating process of the communication apparatus in step S105 of FIG. 4;

FIG. 6 is a subroutine flowchart showing a procedure of a web list generating process of the communication apparatus in step S107 of FIG. 4;

FIG. 7 is a subroutine flowchart showing a procedure of a contact list generating process of the communication apparatus in step S109 of FIG. 4;

FIG. 8 is a flowchart showing an example of a procedure of the home screen display process of the communication apparatus;

FIGS. 9A and 9B are explanatory diagrams briefly showing an example of screens in the procedure of the home screen display process of FIG. 8;

FIG. 10 is a flowchart showing another example of a procedure of the home screen display process of the communication apparatus; and

FIGS. 11A to 11D are explanatory diagrams briefly showing an example of screens in the procedure of the home screen display process of FIG. 10.

### DETAILED DESCRIPTION

In general, according to one embodiment, a communication apparatus includes a storage unit, a generating unit, and a display unit. The storage unit is configured to store operation history each time an operation is performed. The generating unit is configured to retrieve operation history information from the storage unit. And the generating unit is also configured to generate recommended information based on the operation history information. The display unit displays a home screen as a starting point of operation so that the home screen contains the recommended information generated by the generating unit.

Hereinbelow, a description will be given of the communication apparatus according to an embodiment of the present invention with reference to the drawings.

An embodiment of the communication apparatus according to the present invention will be described with reference to the accompanying drawings. The communication apparatus is described by taking as an example a communication apparatus 1 equipped with a display on which the user can input data by touching a screen with a finger or the like (a touch screen) and having a function of generating and displaying a home screen as the starting point of the user's operation based on input on the display.

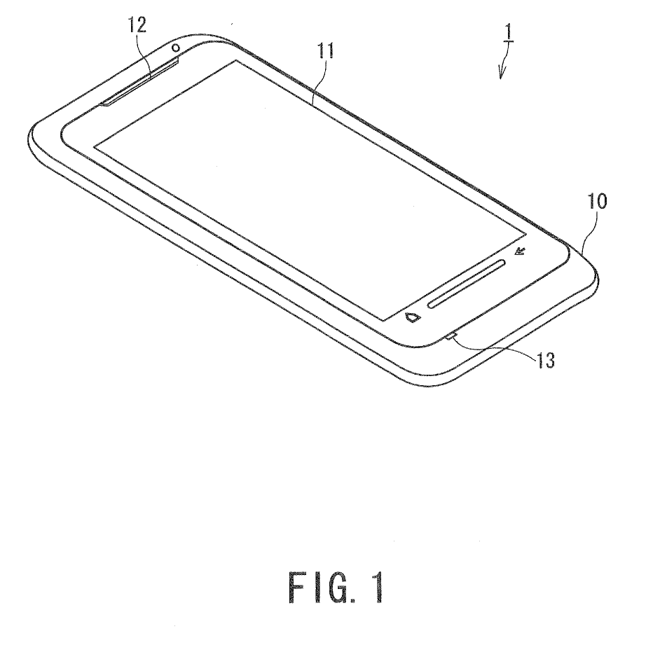

FIG. 1 is schematic external perspective view showing an example of the communication apparatus 1. The communication apparatus 1 has a rectangular, board-like housing 10 as depicted in FIG. 1. On one side of the housing 10, there are provided a touch screen 11 for displaying data as well as allowing data to be input by touching, a speaker 12 for outputting sound, and a microphone 13 for inputting sound.

The touch screen 11 is a display having both a display function to display screen data and an input function to accept input of an instruction by detecting a position of a contact on the screen made by the user with a finger or a dedicated pen. The touch screen 11 is formed by arranging multiple elements for detecting a contact on a surface of a display and further overlaying a transparent sheet on the elements, for example. The touch screen 11 can sense a touch by a pressure-sensitive method which is based on sensing a change in pressure, a capacitive method which is based on sensing an electrical signal utilizing capacitance, or any other method.

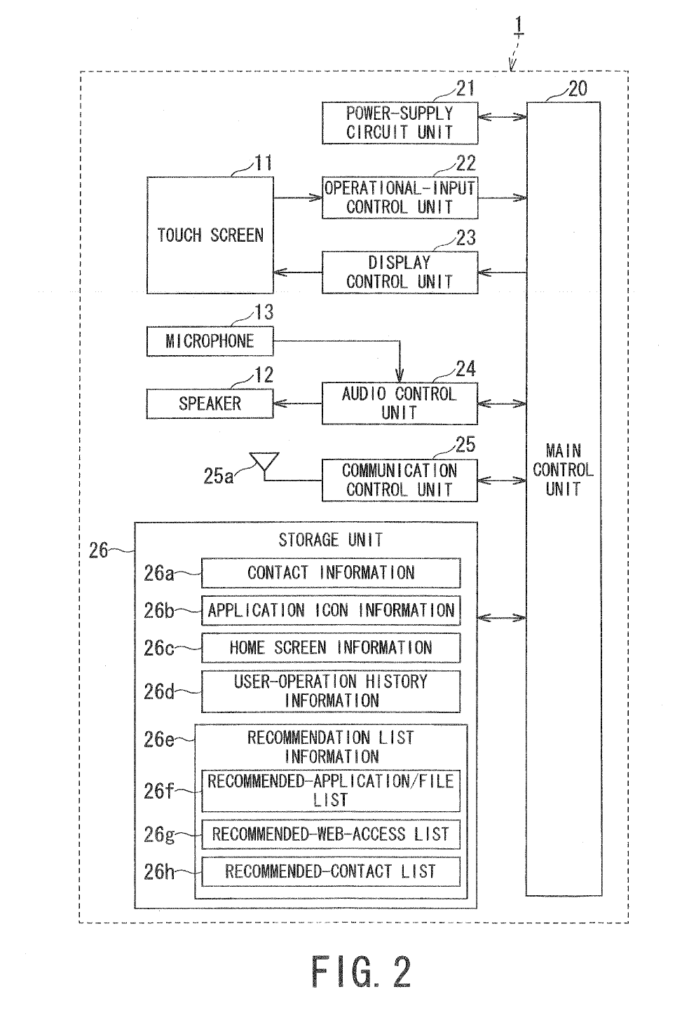

FIG. 2 is a schematic block diagram showing an example of the features of the communication apparatus 1. As shown in FIG. 2, the communication apparatus 1 comprises a main control unit 20, power-supply circuit unit 21, an operational-input control unit 22, a display control unit 23, an audio control unit 24, a communication control unit 25, and a storage unit 26, which are interconnected by a bus to be able to communicate with each other.

The main control unit 20 has a Central Processing Unit (CPU), being responsible for overall control on the communication apparatus 1 as well as display of a home screen described below and execution of various other computations and controls. The power-supply circuit unit 21 has a power source (e.g., a battery), and switches powering on/off of the communication apparatus 1, according to a certain input from the touch screen 11 for example. While the communication apparatus 1 is powered on, the power-supply circuit unit 21 supplies electrical power to components from the power source to make the communication apparatus 1 operable.

The operational-input control unit 22 has an input interface to the touch screen 11, and upon detecting a contact on the touch screen 11, generates a signal indicating the position of the contact and sends the signal to the main control unit 20. Having received the signal, the main control unit 20 performs any of various processes according to the signal. The display control unit 23 has a display interface to the touch screen 11, and generates screen display data and makes the data displayed on the touch screen 11 under the control of the main control unit 20.

The audio control unit 24 generates an analog audio signal from sound collected by the microphone 13 and converts the signal to a digital audio signal under the control of the main control unit 20. Having derived the digital audio signal, the audio control unit 24 converts the digital audio signal into an analog audio signal and outputs the signal from the speaker 12 as sound under the control of the main control unit 20.

The communication control unit 25 has an antenna 25a and applies inverse spectrum spreading to a signal received via the antenna 25a from a base station to reconstruct original data under the control of the main control unit 20. The data can be sent to the audio control unit 24 to be output from the speaker 12, or sent to the display control unit 23 to be displayed on the touch screen 11, or recorded in the storage unit 26, according to instructions from the main control unit 20. Upon receiving audio data collected by the microphone 13, data input via the touch screen 11, or data stored in the storage unit 26, the communication control unit 25 performs spectrum spreading on the data and sends the encoded data to the base station via the antenna 25a under the control of the main control unit 20.

The storage unit 26 comprises a ROM (Read Only Memory), hard disk, or non-volatile memory for storing processing programs and data necessary for processing performed by the main control unit 20, a RAM (Random Access Memory) for temporarily storing data used during processing by the main control unit 20, and the like. A processing program for use when the main control unit 20 performs a home-screen display process described below is stored in the ROM, for example.

The storage unit 26 has also stored therein contact information 26a registered in an address book, application icon information 26b indicating icons for identifying application programs executed on the communication apparatus 1, home screen information 26c indicating various types of information for generating a home screen, user-operation history information 26d indicating the history of the user's operations on the communication apparatus 1, and recommendation list information 26e which includes lists of information items to be recommended to the user (recommended information).

The contact information 26a is address book information, representing information on combinations of a person's name with a picture of his face, telephone number, mail address, and a URL of his/her website (e.g., a blog).

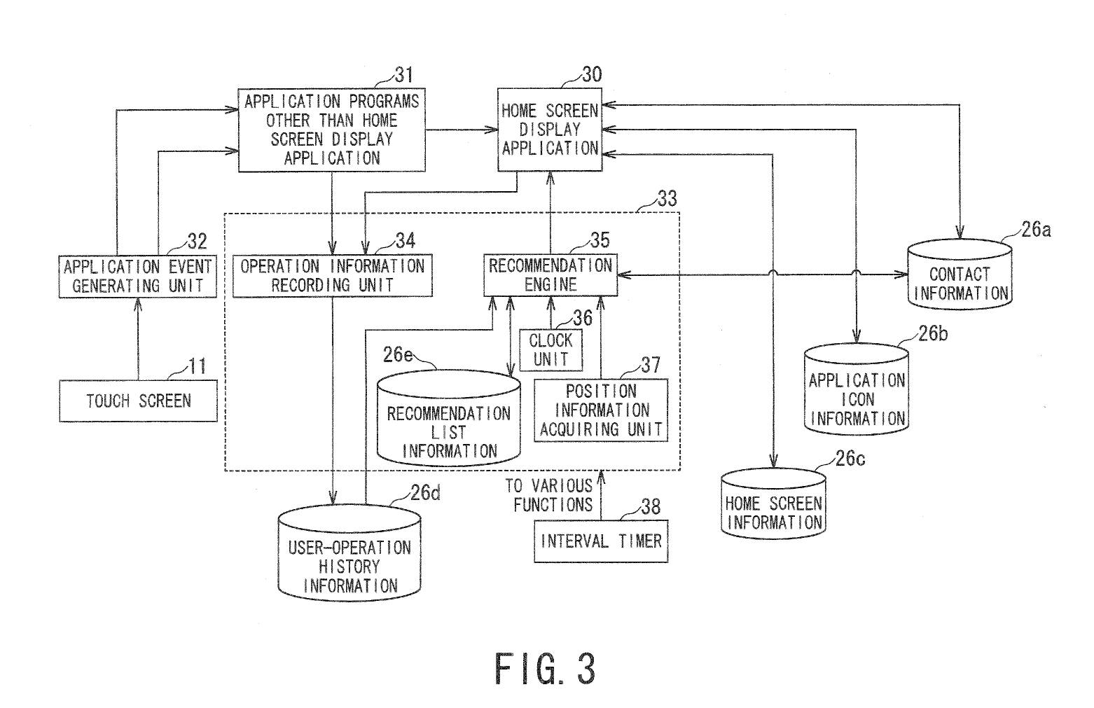

The application icon information 26b is information that associates identification information for individual application programs 31 (to be explained in detail hereinafter with FIG. 3) with icon information, for example. An icon is associated with each application program 31, such as a telephone application program 31 and a mailing application program 31.

The home screen information 26c is information on webpage icons for use on the home screen, for example. Webpage icons are icons associated with various URLs. A webpage icon may be generated and stored in the storage unit 26c at the time of access from the communication apparatus 1 to a webpage or at the time of generating a home screen. Also, the webpage icons include a default icon that can be used for any URL.

The operation history information 26d is information associating operations with their details and date/time, for example. This information is recorded each time the communication apparatus 1 is operated by the user. The details of operation may be activation of a camera application program 31, viewing of a webpage on a web browser 31, activation of an application program 31 for playing a video, viewing or editing of a text or image file stored in the storage unit 26, originating or receiving a telephone call, sending or receiving an e-mail, or the like. For originating/receiving of a telephone call and sending/receiving of an e-mail, a number to call or a destination address may be included as the operation history information corresponding to the operation.

The recommendation list information 26e is information for display as recommended information on the home screen, including a recommended-application/file list 26f, a recommended-web-access list 26g, and a recommended-contact list 26h. The recommended-application/file list 26f is a list of recommended application programs or files. The recommended-web-access list 26g is a list of recommended websites. The recommended-contact list 26h is a list of recommended communication actions, listing pairs of a contact information (including a personal data of a peer) and a communication action.

The communication apparatus 1 has functions of starting display on the touch screen 11 and generating and displaying a home screen on the touch screen 11 when the terminal 1 is powered up or when the terminal 1 returns from a screen non-display mode (a mode in which display on the touch screen 11 is disabled for power saving) to a normal mode (a mode in which display on the touch screen 11 is active), for example. The home screen is a screen from which the user's operation starts, containing shortcut buttons for various application programs 31.

FIG. 3 is a schematic block diagram showing an example of a software configuration of the communication apparatus 1 for displaying the home screen. As shown in FIG. 3, the communication apparatus 1 includes a home screen display application 30, which is an application program for generating and displaying a home screen, and various other application programs 31 for implementing telephone, mailing, and web functions. The communication apparatus 1 realizes various functions through execution of these application programs 30 and 31 by the main control unit 20.

The communication apparatus 1 also has an application event generating unit 32. The application event generating unit 32 generates an event in response to input of data via the touch screen 11 and notifies the application programs 30 and 31 of the event. Upon receiving the event, the home screen display application 30 and/or other application program 31 perform processing corresponding to the event.

The communication apparatus 1 also has a recommended-information generating unit 33 that selects information to be recommended to the user (recommended information) under the control of the home screen display application 30 and notifies the home screen display application 30 of the selected information. The recommended-information generating unit 33 includes an operation information recording unit 34 and a recommendation engine 35.

The operation information recording unit 34 obtains details of a user operation from application programs 30 and 31 and records them in the storage unit 26 as user-operation history information 26d when the application programs 30 and 31, such as calling, mailing, web browsing, camera, and gaming functions, have been operated by the user.

Upon receiving notification from an interval timer 38 on each elapse of a certain time period, the recommendation engine 35 generates and updates recommendation list information 26e based on user-operation history information 26d. When generating the recommendation list information 26e, the recommendation engine 35 gets the current time from a clock unit 36, which keeps track of the current time, or obtains the current position of the communication apparatus 1 from a position information acquiring unit 37. And the recommendation engine 35 selects information to be presented to the user at the current time and position based on some or all of the information obtained.

The recommendation engine 35 also retrieves the recommendation list information 26e from the storage unit 26 according to instructions from the home screen display application 30, and sends the information 26e to the home screen display application 30. The home screen display application 30 generates a home screen based on the information supplied by the recommendation engine 35 and displays the generated home screen on the touch screen 11.

When displaying a screen on the touch screen 11 upon startup of the communication apparatus 1 or transition from the screen non-display mode (a power saving mode) to the screen display mode (a normal mode), the home screen display application 30 acquires the latest recommendation list information 26e from the recommendation engine 35 and also retrieves contact information 26a, application icon information 26b, and home screen information 26c from the storage unit 26 to generate a home screen and displays it on the touch screen 11. Thus, the recommendation engine 35 regularly updates recommended information, and the home screen display application 30 acquires recommended information from the recommendation engine 35 to generate a home screen. This enables the home screen to be rendered in a shorter amount of time.

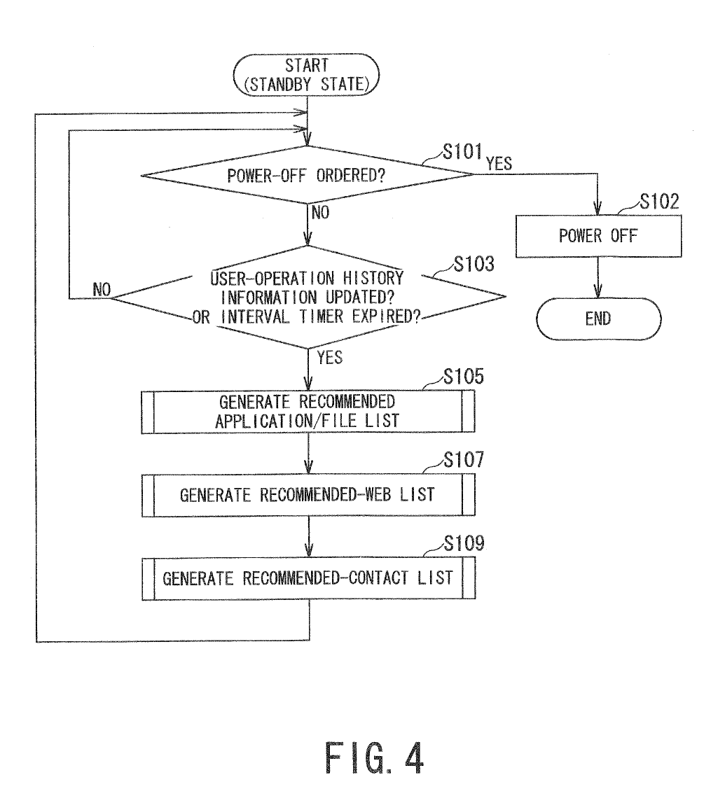

With respect to the flowcharts shown in FIGS. 4 to 7.A, a procedure for the main control unit 20 to perform a recommendation list generating process to periodically generate and update the recommendation list information 26e under control of the recommendation engine 35 will be described. It is assumed that the interval timer 38 notifies the recommendation engine 35 of expiration of the timer at certain time intervals.

The main control unit 20 determines whether power-off has been ordered or not (S101). The main control unit 20 determines that power-off is ordered when a certain operation is done on the touch screen 11, for example. If power-off has been ordered (YES at S101), the main control unit 20 powers off the communication apparatus 1 (S102).

If power-off has not been ordered (NO at S101), the main control unit 20 determines whether the user-operation history information 26d has been updated or not or whether the interval timer 38 has expired or not (S103). If the user-operation history information 26d has not been updated and the interval timer 38 has not expired (NO at S103), the procedure returns to step S101.

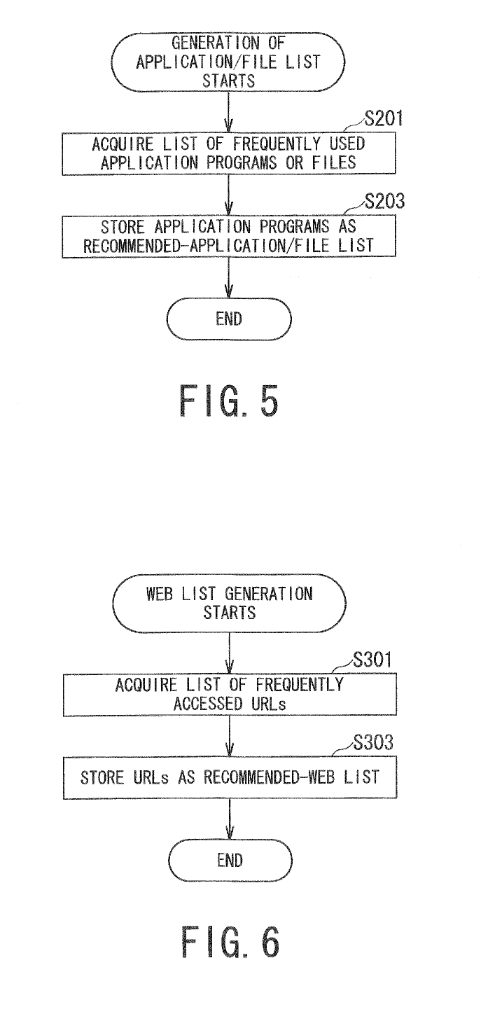

If the user-operation history information 26d has been updated or the interval timer 38 has expired (YES at S103), the main control unit 20 generates and updates the recommended-application/file list 26f (S105). The procedure for the main control unit 20 to generate the application/file list is described with the flowchart shown in FIG. 5.

The main control unit 20 first derives a list of frequently used application programs or files from the user-operation history information 26d stored in the storage unit (S201). The main control unit 20 then stores a recommended-application/file list 26f that is based on the list derived at step S201 in the storage unit 26 (S203). The recommended-application/file list 26f stored here may be the list derived at step S201 itself or a list created by re-sorting or modifying the list based on data acquired from the clock unit 36 and the position information acquiring unit 37.

The main control unit 20 generates and updates the recommended-web list 26g (S107). The procedure for the main control unit 20 to generate the web list is described with the flowchart shown in FIG. 6.

The main control unit 20 first derives a list of frequently accessed URLs from the user-operation history information 26d stored in the storage unit 26 (S301). The main control unit 20 then stores the list derived at step S301 in the storage unit 26 as the recommended-web list 26g (S303). The recommended-web list 26g stored here may be the list derived at step S301 itself or a list created by re-sorting or modifying the list using data acquired from the clock unit 36 and the position information acquiring unit 37.

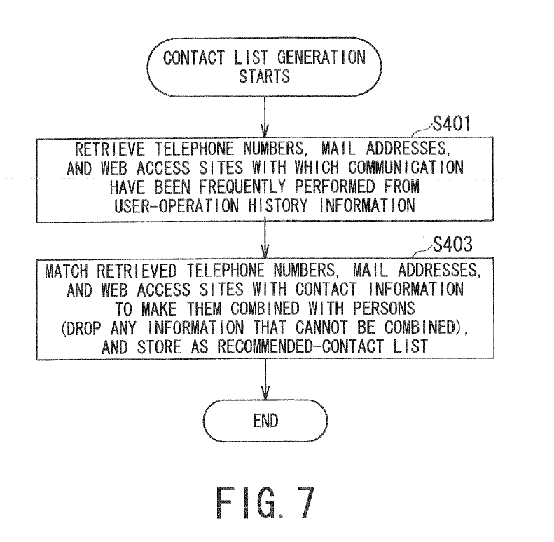

The main control unit 20 generates and updates the recommended-contact list 26h (S109). The procedure for the main control unit 20 to generate the contact list is described with respect to the flowchart shown in FIG. 7.

The main control unit 20 first derives a list of telephone numbers, mail addresses, and web access sites with which communication have been frequently performed from the user-operation history information 26d stored in the storage unit 26 (S401). The main control unit 20 then checks the telephone numbers, mail addresses, and web access sites acquired at step S401 against the contact information 26a, and stores information combining them with corresponding contact information in the storage unit 26 as the recommended-contact list 26h (S403). The recommended-contact list 26h stored here may be the output at step S401 itself but may instead be a list created by re-sorting or modifying the output based on data acquired from the clock unit 36 and the position information acquiring unit 37.

In this manner, the communication apparatus 1 regularly updates the recommendation list information 26e by repeating the processes at steps S101 to S109. Upon transition from the non-display mode to the display mode, the communication apparatus 1 uses the recommendation list information 26e to generate a home screen and displays it on the touch screen 11.

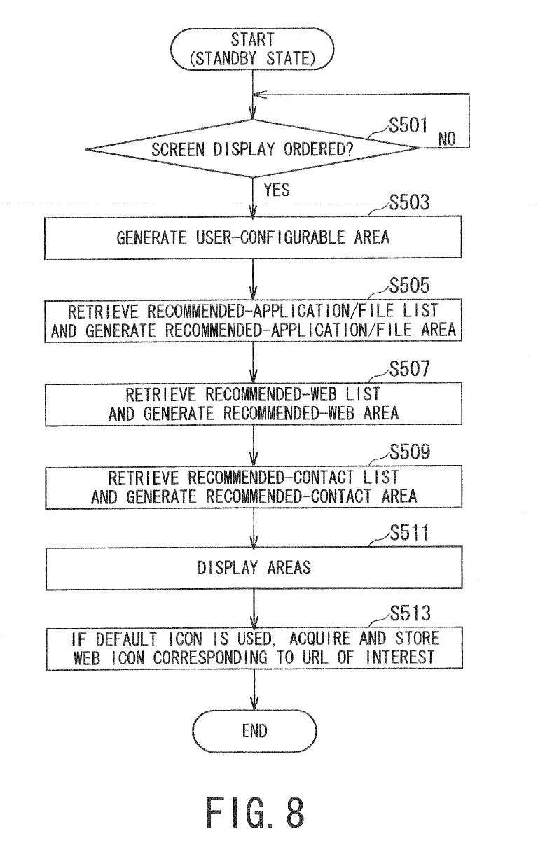

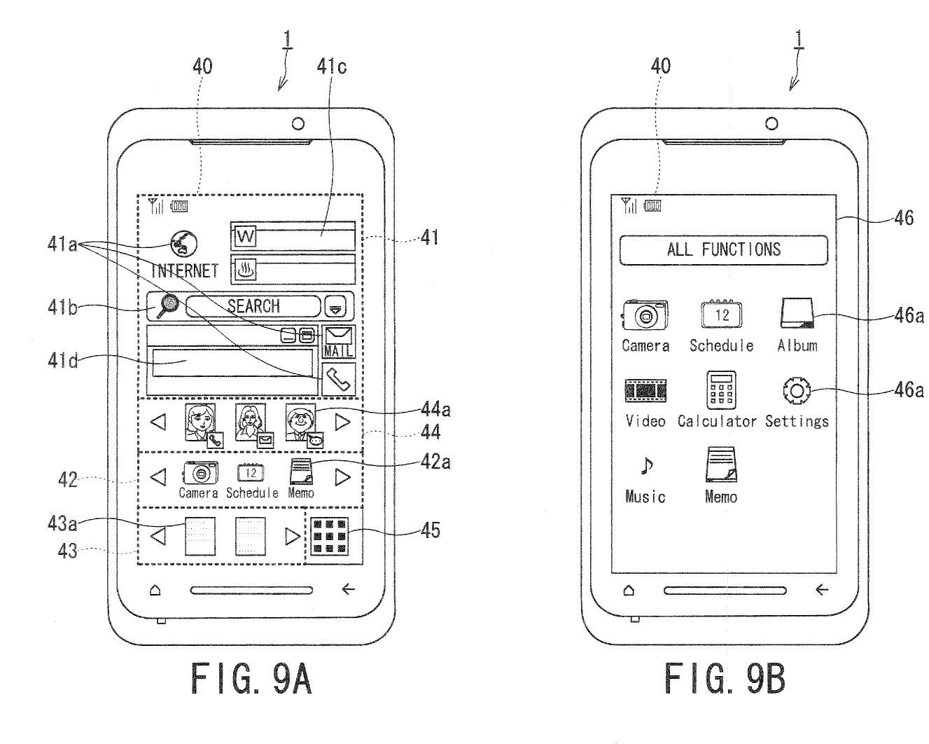

The procedure for the communication apparatus 1 to display the home screen is described with respect to the flowchart shown in FIG. 8 and the diagrams illustrating screens displayed in the procedure of the home screen display process of FIG. 8 shown in FIGS. 9A and 9B. FIG. 9A is explanatory diagrams showing the home screen, and FIG. 9B is explanatory diagrams showing an all-function display screen.

The main control unit 20 performs a home screen display process under the control of the home screen display application 30. It is assumed that no screen is being displayed on the touch screen 11 at the beginning. The main control unit 20 determines whether screen display has been ordered or not (S501). The main control unit 20 determines that screen display has been ordered if the user has touched the touch screen 11 so that the terminal 1 will return from the screen non-display mode to the normal mode, for example. If screen display has not been ordered (NO at S501), the main control unit 20 proceeds to wait.

If screen display has been ordered (YES at S501), the main control unit 20 generates a user-configurable area (S503). FIG. 9A shows an example of the home screen. As shown in FIG. 9A, a user-configurable area 41 is provided on a display area 40 of the touch screen 11. The user-configurable area 41 is an area containing shortcut buttons to start application programs 31 pre-selected by the user. In the user-configurable area 41, there are arranged application shortcut buttons 41a for application programs 31 having mailing or web browsing functions, for example, a search engine widget 41b, an RSS (RDF Site Summary) reader 41c, a SNS (Social Networking Service) widget 41d, and so on. A default layout in the user-configurable area 41 may be preset at the time of shipment.

The main control unit 20 retrieves the recommended-application/file list 26f and generates a recommended-application/file area 42 based on the list (S505). In this process, the main control unit 20 retrieves icons corresponding to the application programs or files contained in the list from the application icon information 26b. And the main control unit 20 arranges shortcut buttons for starting the application programs or files in the recommended-application/file area 42 in the form of icons 42a.

The main control unit 20 retrieves the recommended-web list 26g and generates a recommended-web area 43 based on the list (S507). In this process, the main control unit 20 acquires icons corresponding to the URLs contained in the list from the home screen information 26c, and arranges shortcut buttons for accessing the URLs in the recommended-web area 43 in the form of icons 43a. When the home screen information 26c does not include an icon corresponding to a URL, the main control unit 20 acquires and arranges the default icon from the home screen information 26c.

The main control unit 20 retrieves the recommended-contact list 26h and generates a recommended-contact area 44 based on the list (S509). In this process, the main control unit 20 acquires icons corresponding to the contacts contained in the list (e.g., icons representing images identifying contacts) from the contact information 26a, and also retrieves icons representing telephone, e-mail, and web access functions from the application icon information 26b. The main control unit 20 arranges icons 44a that are combinations of an icon representing a contact and an icon indicating a communication action as shortcut buttons for starting various communication actions. When the contact information 26a contains no contact for telephone or e-mail, or no website provider, a shortcut button for the missing communication action is desirably not be displayed in the recommended-contact area 44.

The main control unit 20 arranges the user-configurable area 41, the recommended-application/file area 42, the recommended-web area 43, and the recommended contact area 44 generated respectively at steps S503, S505, S507, and S509 on the home screen, and displays the home screen on the display area 40 of the touch screen 11 as shown in FIG. 9A (S511). Hereinafter, the recommended-application/file area 42, recommended-web area 43, and recommended-contact area 44 will be generically called recommendation areas.

Also as shown in FIG. 9A, an all-function display button 45 is provided on the display area 40 of the touch screen 11. When the user selects the all-function display button 45, an all-function display screen 46 appears. FIG. 9B illustrates an example of the all-function display screen 46. As shown in FIG. 9B, the all-function display screen 46 contains shortcut buttons 46a for activating each of all functions provided by the communication apparatus 1, such as camera and mailing functions.

When the default icon was used at step S507, the main control unit 20 accesses a URL for which the default icon was used after completion of display of the various areas on the home screen, to acquire a web icon for the website and stores the icon in the storage unit 26 as home screen information 26c (S513). Thereby, the icon stored at step S513 can be used next time a shortcut button for accessing the URL should be displayed.

The descriptions above showed an example of extracting items to be displayed in recommendation areas based on their frequency of use. This is not limitative, however: items that have been recently used may be preferentially extracted, or a list acquired from the recommendation engine 35 may be used as it is, or the list may be re-sorted or sorted out using data obtained from the clock unit 36 and the position information acquiring unit 37.

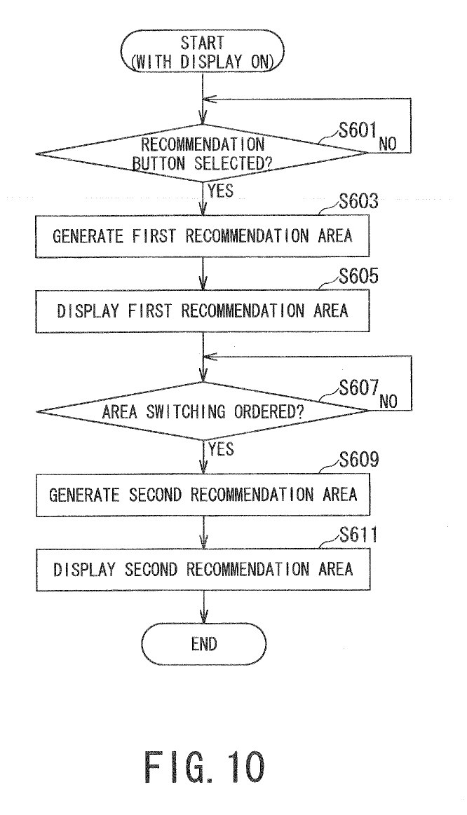

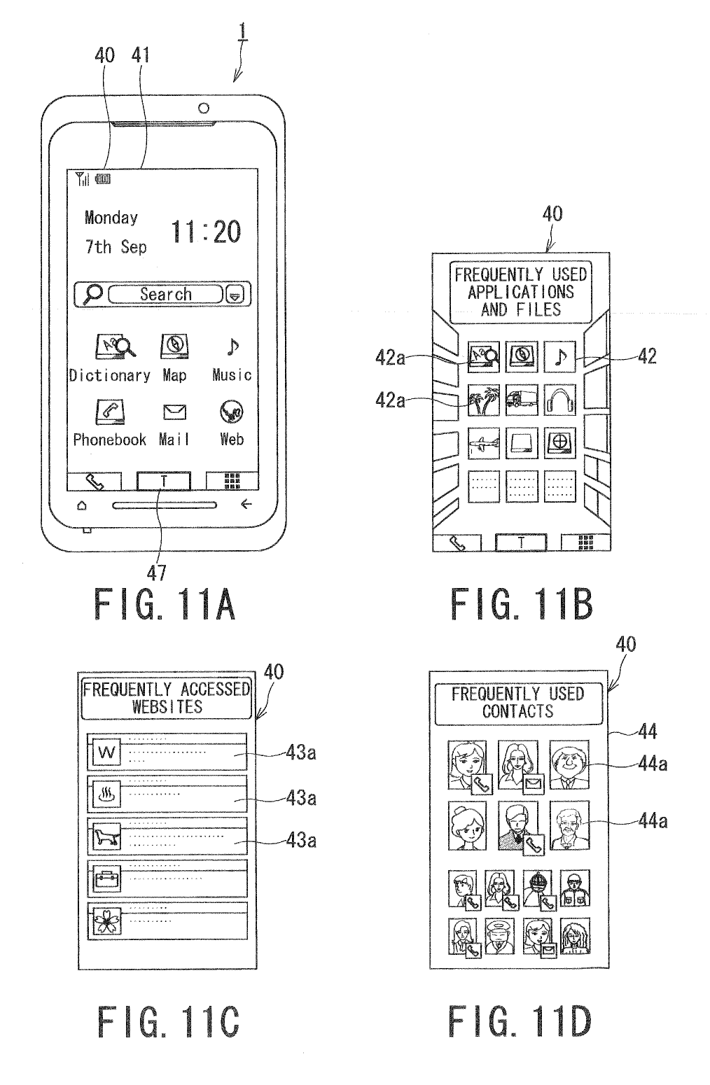

The descriptions above showed an example of displaying recommendation areas as a part of the home screen when the communication apparatus 1 displays the home screen on the touch screen 11. This is not limitative, however: the user-configurable area 41 and a recommendation button 47 (to be explained in detail hereinafter with FIG. 10 and FIGS. 11A to 11D) for displaying recommendation areas 42, 43, and 44 may be displayed on the home screen, and the recommendation areas 42, 43, and 44 may be displayed when the recommendation button 47 is selected by the user.

The procedure of a home screen display process for the communication apparatus 1 to arrange recommendation areas on the home screen according to instructions from the user through the recommendation button 47 or the like and display the home screen is described with respect to the flowchart shown in FIG. 10 and the diagrams illustrating screens displayed in the procedure of the home screen display process of FIG. 10 shown in FIGS. 11A to 11D.

It is assumed that at the beginning the user-configurable area 41 is being displayed in the display area 40 on the touch screen 11 as shown in FIG. 11A. The main control unit 20 determines whether the recommendation button 47 has been selected or not (S601). If the recommendation button 47 has not been selected (NO at S601), the main control unit 20 proceeds to wait.

If the recommendation button 47 has been selected (YES at S601), the main control unit 20 generates a first recommendation area (S603). The first recommendation area may be any of the above-described recommendation areas, which may be a preset one or frequently used one. It is assumed that the first recommendation area is the recommended-application/file area 42. Here, the recommended-application/file area 42 is generated in the manner described at step S505, the recommended-web area 43 is in the manner described at step S507, and the recommended-contact area 44 is in the manner described at step S509.

The main control unit 20 displays the recommendation area generated at step S603 on the display area 40 of the touch screen 11 (S605). The recommended-application/file area 42 is displayed in the display area 40 of the touch screen 11 as depicted in FIG. 11B, for example.

The main control unit 20 determines whether area switching has been ordered by the user or not (S607). The main control unit 20 determines that area switching is ordered if switching is requested through a predetermined operation by the user, e.g., the surface of the touch screen 11 is rubbed for a predetermined time period or longer. If area switching has not been ordered (NO at S607), the main control unit 20 proceeds to wait.

If area switching has been ordered (YES at S607), the main control unit 20 generates a second recommendation area (S609). The second recommendation area is a recommendation area different from the first recommendation area. In this example, the second recommendation area is the recommended-web area 43 (see FIG. 11C) or the recommended-contact area 44 (see FIG. 11D), for example. Here, the recommended-application/file area 42 is generated in the manner described at step S505, the recommended-web area 43 is in the manner described at step S507, and the recommended-contact area 44 is in the manner described at step S509.

The main control unit 20 displays the recommendation area generated at step S609 on the display area 40 of the touch screen 11 (S611). When the second recommendation area is the recommended-web area 43, for example, the recommended-web area 43 is shown in the display area 40 of the touch screen 11 as depicted in FIG. 11C. When the second recommendation area is the recommended-contact area 44, for example, the recommended-contact area 44 is shown in the display area 40 of the touch screen 11 as depicted in FIG. 11D.

The communication apparatus 1 thus acquires the latest output from the recommendation engine 35 at the time of screen display (when the communication apparatus 1 is started up or returns from screen non-display mode), and provides the latest information on application/files, telephone calling, e-mail composition, and web browsing with contact information, and websites based on the output of the recommendation engine 35 as icons on the screen of the touch screen 11.

At the same time, to preserve traditional usability, the communication apparatus 1 provides the user-configurable area 41 to display icons preselected by the user, a link icon for an all-function display screen associated with all functions of the communication apparatus 1 (i.e., the all-function display button 45), and areas in which shortcuts are automatically set up based on recommendation output (i.e., the recommendation areas 42, 43, and 44).

In addition, in consideration of practical utility, the recommendation areas are organized by purpose, such as the recommended-application/file area 42, recommended-web area 43, and recommended-contact area 44. These areas may also be implemented in widgets. Layout of the recommendation areas is desirably user configurable. The recommendation areas are desirably configured to allow the user to see less recommended shortcut buttons by scrolling on the screen with a finger.

According to the communication apparatus 1 according to this embodiment, a home screen with excellent user operability can be displayed by acquiring and displaying the latest recommended information on the screen at the start of screen display.

While certain embodiments have been described, these embodiments have been presented by way of example only, and are not intended to limit the scope of the inventions. Indeed, the novel apparatuses described herein may be embodied in a variety of other forms; furthermore, various omissions, substitutions and changes in the form of the apparatuses described herein may be made without departing from the spirit of the inventions. The accompanying claims and their equivalents are intended to cover such forms or modifications as would fall within the scope and spirit of the inventions.

For example, while the communication apparatus 1 has been illustrated for description of the embodiment, this is not limitative and the present invention is applicable to any communication apparatus that is capable of displaying a home screen, such as a mobile phone, PHS (Personal Handy phone System), PDA (Personal Digital Assistant), MID (Mobile Internet Device), portable music player, portable video camera, and portable gaming machine.

1. A communication apparatus comprising:
a storage unit configured to store operation history each time an operation is performed;
a generating unit configured to retrieve operation history information from the storage unit and configured to generate recommended information based on the operation history information; and
a display unit configured to display a home screen as a starting point of operation so that the home screen contains the recommended information generated by the generating unit.

2. A communication apparatus comprising:
a storage unit configured to store operation history each time an operation is performed;
a generating unit configured to retrieve operation history information from the storage unit and configured to generate recommended information based on the operation history information;
a first accepting unit configured to accept an instruction for display of the recommended information; and
a display unit configured to display a home screen as a starting point of operation so that the home screen contains the recommended information generated by the generating unit when the instruction has been accepted by the first accepting unit.

3. The communication apparatus according to claim 1, wherein
the storage unit is configured to store operation history of an application program each time the application program is operated;
the generating unit is configured to retrieve operation history information of application programs from the storage unit and is configured to generate a list of application programs based on the operation history information; and
the display unit is configured to display the home screen so as to contain the list of application programs generated by the generating unit.

4. The communication apparatus according to claim 1, wherein
the storage unit is configured to store operation history of a web browser along with a URL accessed each time the web browser is operated;
the generating unit is configured to retrieve operation history information of the web browser from the storage unit and is configured to generate a list of URLs based on the operation history information; and
the display unit is configured to display the home screen so as to contain the list of URLs generated by the generating unit.

5. The communication apparatus according to claim 4, wherein
the display unit is configured to acquire page information for the URLs in the list of URLs generated by the generating unit, and is configured to generate starting icons for the respective URLs from the page information, and is configured to include the starting icons in the home screen.

6. The communication apparatus according to claim 1, wherein
the storage unit is configured to store operation history of a function along with a contact information including a personal data of a peer each time a telephone calling function or a mailing function is operated;
the generating unit is configured to retrieve operation history information of the telephone calling function or the mailing function and is configured to generate a list of pairs of the contact information and a type of operation based on the operation history information; and
the display unit is configured to display the home screen so as to contain the list of pairs of the contact information and the type of operation generated by the generating unit.

7. The communication apparatus according to claim 1, wherein
the storage unit is configured to store operation history of a web browsing function along with a contact information including a personal data of a peer each time the web browsing function is operated;
the generating unit is configured to retrieve operation history information of the web browsing function and is configured to generate a list of pairs of a website URL and the contact information based on the operation history information; and
the display unit is configured to display the home screen so as to contain the list of pairs of the website URL and the contact information generated by the generating unit.

8. The communication apparatus according to claim 2, wherein
the storage unit is configured to store operation history of an application program each time the application program is operated;
the generating unit is configured to retrieve operation history information of application programs from the storage unit and is configured to generate a list of application programs based on the operation history information; and the display unit is configured to display the home screen so as to contain the list of application programs generated by the generating unit.

9. The communication apparatus according to claim 2, wherein
the storage unit is configured to store operation history of a web browser along with a URL accessed each time the web browser is operated;
the generating unit is configured to retrieve operation history information of the web browser from the storage unit and is configured to generate a list of URLs based on the operation history information; and
the display unit is configured to display the home screen so as to contain the list of URLs generated by the generating unit.

10. The communication apparatus according to claim 2, wherein
the storage unit is configured to store operation history of a function along with a contact information including a personal data of a peer each time a telephone calling function or a mailing function is operated;
the generating unit is configured to retrieve operation history information of the telephone calling function or the mailing function and is configured to generate a list of pairs of the contact information and a type of operation based on the operation history information; and
the display unit is configured to display the home screen so as to contain the list of pairs of the contact information and the type of operation generated by the generating unit.

11. The communication apparatus according to claim 2, wherein
the storage unit is configured to store operation history of a web browsing function along with a contact information including a personal data of a peer each time the web browsing function is operated;
the generating unit is configured to retrieve operation history information of the web browsing function and is configured to generate a list of pairs of a website URL and the contact information based on the operation history information; and
the display unit is configured to display the home screen so as to contain the list of pairs of the website URL and the contact information generated by the generating unit.
